(19) United States
(12) Patent Application Publication
(10) Pub. No.: US 2026/0074638 A1
(43) Pub. Date: Mar. 12, 2026

(54) BRUSHLESS DIRECT CURRENT MOTOR CONTROL METHOD BASED ON IMPROVED PID CONTROLLER

(71) Applicant: Dongguan University of Technology, Dongguan (CN)

(72) Inventors: Ruirong LIU, Dongguan (CN); Jianguo WANG, Dongguan (CN)

(21) Appl. No.: 18/921,323

(22) Filed: Oct. 21, 2024

(30) Foreign Application Priority Data
Sep. 10, 2024 (CN) 202411266957.0

(51) Int. Cl. H02P 23/00; H02P 23/14

(52) U.S. Cl. CPC H02P 23/0004; H02P 23/14

(57) ABSTRACT

Provided is a brushless direct current (BLDC) motor control method based on an improved proportional integral derivative (PID) controller, relating to the field of motor control. The method of this application comprises: establishing a squared proportional integral derivative (SPID) controller integrating a squared error term; determining a sign of a gain coefficient of the squared error term in the SPID controller based on an error between an actual speed and a target speed of a BLDC motor; determining whether to enable a derivative term of the SPID controller based on whether the actual speed has reached the target speed; using the error between the actual speed and the target speed as an input amount to the SPID controller, and outputting a current control amount; and performing speed control on the BLDC motor based on the current control amount until the error meets an accuracy requirement.

### CROSS REFERENCE TO RELATED APPLICATION

This patent application claims the benefit and priority of Chinese Patent Application No. 2024112669570, filed with the China National Intellectual Property Administration on Sep. 10, 2024, the disclosure of which is incorporated by reference herein in its entirety as part of the present application.

### TECHNICAL FIELD

The present disclosure relates to the technical field of motor control, and in particular, to a brushless direct current (BLDC) motor control method based on an improved proportional integral derivative (PID) controller.

### BACKGROUND

Brushless direct current (BLDC) motors have been successfully applied in fields such as robotics, textiles, and electric vehicles due to their simple structure, high efficiency, low maintenance costs, and fast dynamic response. High-performance BLDC control systems have become a research hotspot for many scholars. In BLDC control systems, proportional integral derivative (PID) controllers are commonly used for speed regulation. The PID controller calculates an output signal through a combination of proportional gain, integral gain, and derivative gain to achieve precise control of a controlled object. While PID controllers are simple in structure, easy to implement, and robust, they have some issues in technical applications. For example, PID control is highly dependent on the selection of gain parameters, which may lead to a decline in the performance of the BLDC motor.

### SUMMARY

To address the issues mentioned in the background technology, the present disclosure provides a BLDC motor control method based on an improved PID controller, aiming to enable a BLDC motor system to reach a target value faster and more stably, reduce system overshoot, and enhance the anti-interference capability of the system.

To achieve the above objective, the present disclosure provides the following technical solution.

The present disclosure provides a BLDC motor control method based on an improved PID controller, including:
S1: establishing a squared proportional integral derivative (SPID) controller integrating a squared error term, where the established SPID controller is expressed as follows:

$$u ( t ) = {K}_{s} {e}^{2} ( t ) + {K}_{P} e ( t ) + {K}_{I} {\int }_{0}^{t} e ( t ) d t + {K}_{D} \frac{d e ( t )}{d t} ;$$

e(t) represents an error between an actual speed and a target speed of a BLDC motor; e²(t) represents the squared error term; K_{S} represents a gain coefficient of the squared error term; t represents time; K_{P} represents a proportional gain; K_{I} represents an integral gain; K_{D} represents a derivative gain; and u(t) represents a current control amount output by the SPID controller;
S2: determining a sign of the gain coefficient of the squared error term in the SPID controller based on the error between the actual speed and the target speed of the BLDC motor;
S3: determining whether to enable a derivative term of the SPID controller based on whether the actual speed has reached the target speed;
S4: using the error between the actual speed and the target speed as an input amount to the SPID controller, and outputting a current control amount; and
S5: performing speed control on the BLDC motor based on the current control amount until the error meets an accuracy requirement.

According to specific embodiments provided in the present disclosure, the present disclosure discloses the following technical effects:
The present disclosure provides a BLDC motor control method based on an improved PID controller, which integrates a squared error term into a traditional PID controller and employs a threshold for enabling the derivative term, thereby constructing the SPID controller. The sign of the gain coefficient of the squared error term is determined based on the sign of the difference e(t) between the actual speed and the target speed of the motor, and it is determined whether to enable the derivative term based on whether the current speed has reached the target speed. The current error e(t) is used as the input amount to the SPID controller, and the current control amount u(t) is output. The above steps are repeated until e(t) meets the accuracy requirement, thereby achieving speed control of the BLDC motor. The SPID controller provided by the present disclosure significantly enhances the response speed of the motor system, avoids excessive overshoot, strengthens the anti-interference capability of the system, and shortens the stabilization time.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a BLDC control method based on an improved PID controller;

FIG. 2 is a structural block diagram of an SPID controller;

FIG. 3 is a schematic diagram of a working process of the SPID controller;

FIG. 4 is a block diagram of a brushless direct current (BLDC) motor speed regulation system used to verify a control effect of the SPID controller; and

FIG. 5 is a comparison chart of effects of BLDC motor control under SPID control and traditional PID control.

### DETAILED DESCRIPTION OF THE EMBODIMENTS

The following clearly and completely describes the technical solutions in the embodiments of the present disclosure, to allow persons skilled in the art to better understand the technical details as well as the advantages and features of the present disclosure, thereby defining the protection scope of the present disclosure more clearly and explicitly. The embodiments described in the present disclosure are only some rather than all of the embodiments of the present disclosure. All other embodiments obtained by those of ordinary skill in the art based on the embodiments of the present disclosure without creative efforts should fall within the protection scope of the present disclosure.

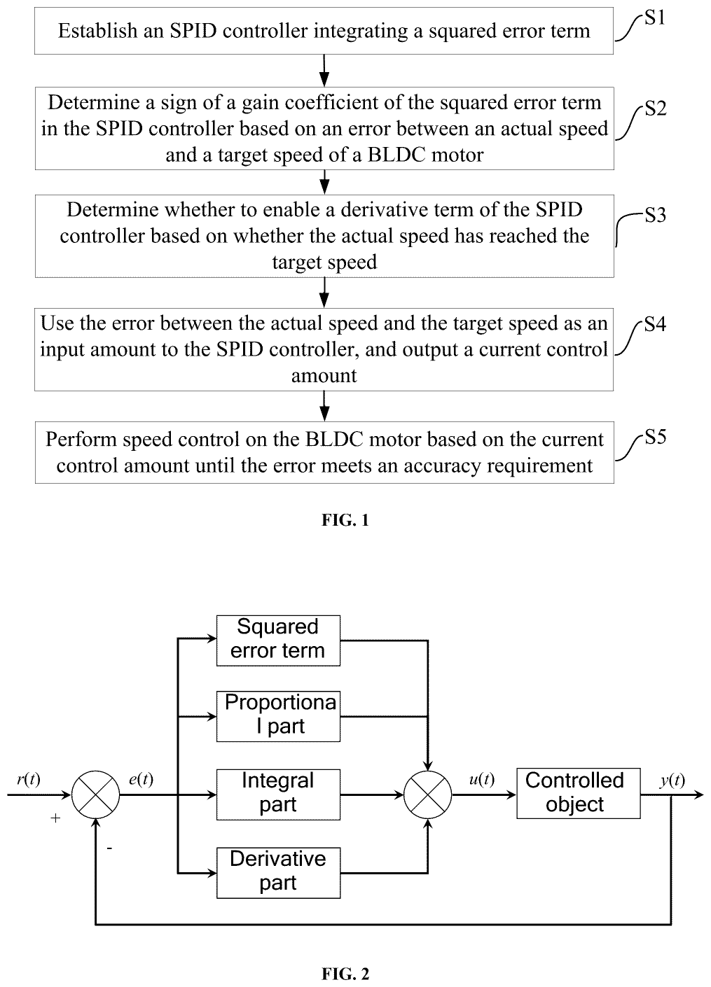

In some embodiments, the present disclosure provides a BLDC motor control method based on an improved PID controller, including steps S1 to S5 shown in FIG. 1, which are described in detail as follows:

S1: Establish an SPID controller integrating a squared error term.

The present disclosure establishes an improved PID controller, referred to as the SPID controller, by integrating a squared error term into a traditional PID controller and employing a threshold for enabling a derivative term. The structure of the SPID controller is shown in FIG. 2, which includes a squared error term, a proportional part, an integral part, and a derivative part. Specifically, the SPID controller is expressed as follows:

$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} \qquad ( 1 )$$

e(t) represents an error between an actual speed y(t) and a target speed r(t) of a BLDC motor; e²(t) represents a squared error term; K_{S} represents a gain coefficient of the squared error term. K_{P} represents a proportional gain; K_{I} represents an integral gain; and K_{D} represents a derivative gain. The proportional gain K_{P} enhances the sensitivity of the system to errors, the integral gain K_{I} eliminates steady-state errors of the system, and the derivative gain K_{D} suppresses system oscillations. t represents time; u(t) represents a current control amount output by the SPID controller. A controlled object in the present disclosure is the BLDC motor. Definitely, in practical applications, the inventive concept of the present disclosure can also be applied to other types of motors.

S2: Determine a sign of a gain coefficient of the squared error term in the SPID controller based on an error between an actual speed and a target speed of a BLDC motor.

The sign of K_{S} plays a decisive role in determining whether the squared error term increases or decreases the system input, and the selection of the sign of K_{S} will be determined based on the error e(t). e(t) is expressed as follows:

$$e ( t ) = r ( t ) - y ( t ) \qquad ( 2 )$$

where r(t) represents a target value, i.e., the target speed of the BLDC motor; y(t) represents an actual output value, i.e., the actual speed of the BLDC motor. The sign of K_{S} is expressed as follows:

$$sgn ( {K}_{S} ) = sgn ( e ( t ) ) \qquad ( 3 )$$

The value of K_{S} is expressed as follows:

$${K}_{S} = \frac{{K}_{S}^{′}}{r ( t )} \qquad ( 4 )$$

where K′_{S}∈[0,1], that is, K′_{S} is a set value ranging from 0 to 1.

From formula (3), it can be seen that if e(t)>0, K_{S} takes a positive value; conversely, if e(t)<0, K_{S} takes a negative value.

S3: Determine whether to enable a derivative term of the SPID controller based on whether the actual speed has reached the target speed.

If the derivative term starts to brake early when the system is starting from rest, the response speed of the system will be slowed down. Therefore, to accelerate the system response, based on the establishment of the SPID controller, the present disclosure employs a threshold for enabling the derivative term. Specifically, when the system output has not reached the target value or when the target value changes, K_{D}=0. After the system reaches the target value, K_{D} is set to a predetermined value.

Specifically, after the BLDC motor starts, if the actual speed has not reached the target speed, the derivative term of the SPID controller is disabled, and K_{D}=0. At this time, the SPID controller is expressed as follows:

$$u ( t ) = {K}_{s} {e}^{2} ( t ) + {K}_{P} e ( t ) + {K}_{I} {\int }_{0}^{t} e ( t ) dt .$$

Conversely, if the actual speed has reached the target speed, the derivative term is enabled, and K_{D} is set to a predetermined value. At this time, the SPID controller is expressed as follows:

$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} .$$

S4: Use the error between the actual speed and the target speed as an input amount to the SPID controller, and output a current control amount.

A target speed value is set for the BLDC motor, and actual speed data output in real time by the BLDC motor is collected through a Hall sensor and input into the BLDC motor controller. The current error e(t) between the actual speed and the target speed is calculated as the input amount to the SPID controller, thereby calculating the system input required to achieve the target value, i.e., the current control amount u(t). The SPID controller calculates the input u(t) to the system in each cycle.

S5: Perform speed control on the BLDC motor based on the current control amount until the error meets an accuracy requirement.

A pulse width modulation (PWM) signal corresponding to the current control amount u(t) is amplified by a three-phase inverter and then input to the BLDC motor for driving. The actual speed of the BLDC motor is collected through a Hall sensor, and steps S2 to S5 are repeated until the error e(t) meets the accuracy requirement.

The present disclosure provides a BLDC motor control method based on an improved PID controller, which increases the system sensitivity to errors by integrating a squared error term. A threshold for enabling the derivative term is employed, such that the derivative term is enabled only after the system first reaches the target value. The error is input into the SPID controller, and the output value is fed into the BLDC motor to achieve speed control for the motor. The present disclosure allows the system to reach the target value faster and more stably without producing excessive overshoot, while also further enhancing the sensitivity of the system to errors and improving the anti-interference capability of the system.

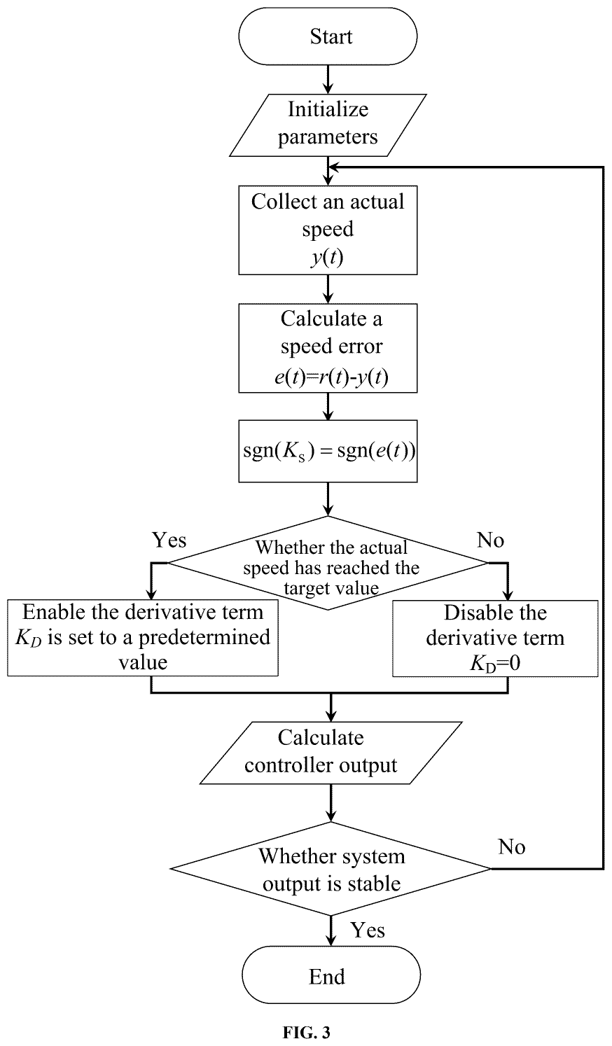

As shown in FIG. 3, for a specific BLDC motor system and a specific target value r(t), the working process of the SPID controller of the present disclosure is as follows:
i. Initialize parameters of the SPID controller: Set the values of K_{S}, K_{P}, K_{I}, K_{D}, and r(t), and input these values into the BLDC motor control system.

The BLDC motor control system used in this embodiment consists of a BLDC motor, a motor driver board, a Hall sensor, a power supply, a motor controller, a hysteresis brake, and a hysteresis controller. All control and adjustment in the system are completed by the motor controller, which directly outputs PWM signals. The PWM signals are amplified by the motor driver board to drive the BLDC motor. The Hall sensor is used to collect the actual speed y(t) of the motor. The BLDC motor and the hysteresis brake are connected via a coupling. The load size of the hysteresis brake is set by the hysteresis controller. The SPID controller is essentially a part of the motor controller. The motor controller performs tasks such as actual speed collection and PWM signal output, while the SPID controller calculates u(t) required for the system input, where u(t) refers to the PWM signal.

An initial value of K_{S} is calculated based on formula (4), while initial values of K_{P}, K_{I}, and K_{D} are mainly set according to needs of a controlled system. When a change in the motor speed is required, it involves updating the target value, for example, changing the speed from 500 r/min to 1000 r/min, at which point the target value will be updated.
ii. Collect, through the Hall sensor, the actual speed y(t) output by the BLDC motor and pass the actual speed to the motor controller. Calculate the motor speed error e(t)=r(t)−y(t) based on the set target value r(t).
iii. The SPID controller determines the sign of K_{S} based on formula (3). If e(t)>0, K_{S} takes a positive value; conversely, if e(t)<0, K_{S} takes a negative value.
iv. If the system output has never reached the target value or when the target value is updated, set K_{D}=0 to disable the derivative term. At this time, the SPID controller is expressed as follows:

$$u ( t ) = {K}_{S} {e}^{2} ( t ) + {K}_{P} e ( t ) + {K}_{I} {\int }_{0}^{t} e ( t ) dt .$$

Conversely, if the system output reaches the target value, K_{D} is set to a predetermined value to enable the derivative term. At this time, the expression is:

$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} ,$$

and the controller output u(t) is calculated. Return to step ii until the system output y(t) stabilizes within a target range.

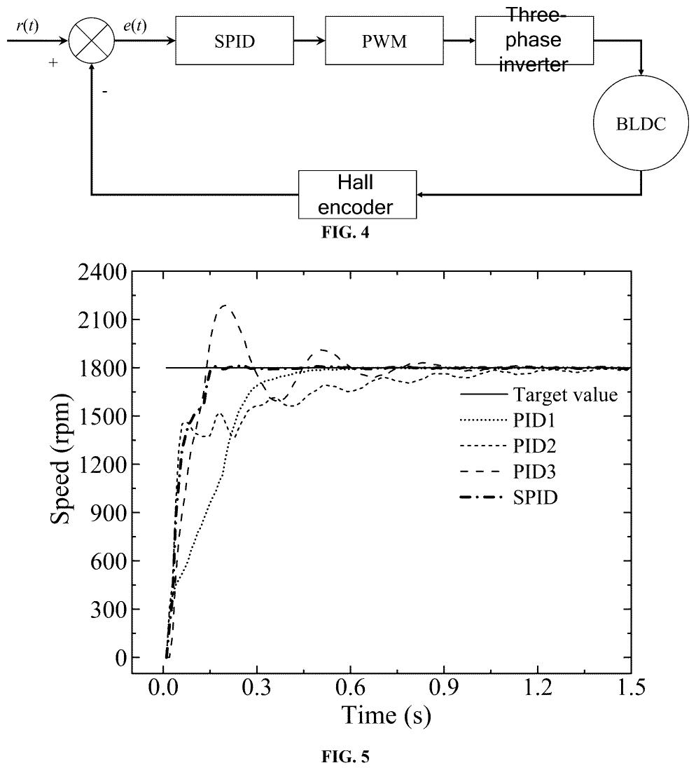

FIG. 4 is a block diagram of a BLDC motor speed regulation system used to verify the performance of the SPID controller according to the present disclosure. The speed regulation system first sets the target value r(t), then calculates the error e(t) by subtracting the actual speed y(t) collected by the Hall sensor from the target value. The resulting error is sent to the SPID controller for calculation, determining the input u(t) required for the system, where u(t) refers to the PWM signal. The PWM signal then needs to be amplified by a three-phase inverter before being input to the motor for driving. The performance of the SPID controller is verified primarily based on the actual speed of the motor. If the actual speed of the motor can reach the target value in a short time without producing significant overshoot, it indicates that the SPID controller is effective. The specific verification process is provided below.
1) Set controller parameters. The target value r(t) is set to 1800 rpm with a load of 0.2 N·m. To compare the advantages and disadvantages of the SPID controller and the traditional PID controller, four different control schemes are used. Parameters of the PID1 controller are as follows: K_{P}=0.30703, K_{I}=0.05602, K_{D}=0.48138; parameters of the PID2 controller are as follows: K_{P}=1.55703, K_{I}=0.05602, K_{D}=0.48138; parameters of the PID3 controller are as follows: K_{P}=0.30703, K_{I}=0.15213, K_{D}=0.48138; parameters of the SPID controller are as follows: K_{P}=0.30703, K_{I}=0.15213, K_{D}=0.48138,

$${K}_{{S}_{= 0.7}}^{′} , {K}_{S} = \frac{{K}_{S}^{′}}{r ( t )} .$$

2) Collect a real-time speed y(t) of the BLDC motor through the Hall sensor, and input the speed y(t) into the SPID controller. The motor speed error e(t)=r(t)−y(t) is calculated based on the set target value r(t)
3) For the SPID controller: when e(t)>0, K_{S} takes a positive value; conversely, when e(t)<0, K_{S} takes a negative value.
4) For the SPID controller: if the system output has never reached the target value, K_{D}=0, where in this case, the expression is:

$$u ( t ) = {K}_{S} {e}^{2} ( t ) + {K}_{P} e ( t ) + {K}_{I} {\int }_{0}^{t} e ( t ) dt ;$$

conversely, if the system output reaches the target value for the first time, set K_{D} to a predetermined value, where in this case, the expression is:

$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} ;$$

and calculate the system input u(t) required for the target value. Return to step 2) until the system stabilizes within the target range.

FIG. 5 shows a comparison of effects of traditional PID control and SPID control on the BLDC motor, with a target speed value set to 1800 rpm. As shown in FIG. 5, in the PID1 controller system, there is almost no overshoot, but the speed rises too slowly, resulting in a long stabilization time. To address the slow speed rise in PID1, the proportional gain is increased in the PID2 controller. Although the response is extremely fast and the initial rise time is shortened, the speed later rises slowly and exhibits oscillation, leading to an even longer stabilization time. In light of this, the integral gain is increased in the PID3 controller. Although the response is faster and the rise time is significantly shortened, the system experiences considerable overshoot and oscillation, resulting in a longer stabilization time. In contrast, after adopting the SPID controller, which integrates a squared error term and employs a threshold for enabling the derivative term, the system not only greatly improves response speed and significantly shortens stabilization time under the same parameter conditions as PID3, but also markedly reduces overshoot, demonstrating clear advantages.

The present disclosure introduces a squared error term based on PID control, increasing the sensitivity of the system to errors and shortening the response time of the system. Additionally, the integration of the squared error term effectively suppresses large errors, enhancing the anti-interference capability of the system. Finally, by employing a threshold for enabling the derivative term, the derivative term is not enabled when the system has not reached the target value or when the target value is updated; instead, the derivative term is only enabled after the system first reaches the target value, further improving the response speed and stability of the system.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A brushless direct current (BLDC) motor control method based on an improved proportional integral derivative (PID) controller, comprising:
S1: establishing a squared proportional integral derivative (SPID) controller integrating a squared error term;
S2: determining a sign of a gain coefficient of the squared error term in the SPID controller based on an error between an actual speed and a target speed of a BLDC motor;
S3: determining whether to enable a derivative term of the SPID controller based on whether the actual speed has reached the target speed;
S4: using the error between the actual speed and the target speed as an input amount to the SPID controller, and outputting a current control amount; and
S5: performing speed control on the BLDC motor based on the current control amount until the error meets an accuracy requirement.

2. The BLDC motor control method based on an improved PID controller according to claim 1, wherein said establishing the SPID controller integrating the squared error term specifically comprises:
establishing the SPID controller based on the following expression:
$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} ,$$
wherein e(t) represents the error between the actual speed and the target speed of the BLDC motor; e² (t) represents the squared error term; K_{S} represents the gain coefficient of the squared error term; t represents time; K_{P} represents a proportional gain; K_{I} represents an integral gain; K_{D} represents a derivative gain; and u(t) represents the current control amount output by the SPID controller.

3. The BLDC motor control method based on an improved PID controller according to claim 2, wherein said determining the sign of the gain coefficient of the squared error term in the SPID controller based on the error between the actual speed and the target speed of the BLDC motor specifically comprises:
calculating the error e(t) between the actual speed y(t) and the target speed r(t) of the BLDC motor based on the following formula: e(t)=r(t)−y(t); and
determining the sign of the gain coefficient K_{S} of the squared error term based on the following formula: sgn(K_{S})=sgn(e(t)).

4. The BLDC motor control method based on an improved PID controller according to claim 3, wherein said determining whether to enable the derivative term of the SPID controller based on whether the actual speed has reached the target speed specifically comprises:
after the BLDC motor starts, if the actual speed has not reached the target speed, disabling the derivative term of the SPID controller, and setting K_{D}=0, wherein the SPID controller is expressed as follows:
$$u ( t ) = {K}_{S} {e}^{2} ( t ) + {K}_{P} e ( t ) + {K}_{I} {\int }_{0}^{t} e ( t ) dt ;$$
and
conversely, if the actual speed has reached the target speed, enabling the derivative term, and setting K_{D} to a predetermined value, wherein, the SPID controller is expressed as follows:
$$u ( t ) = {K}_{S} {e}^{2} ( t ) + {K}_{P} e ( t ) + {K}_{I} {\int }_{0}^{t} e ( t ) dt + {K}_{D} \frac{de ( t )}{dt} .$$

5. The BLDC motor control method based on an improved PID controller according to claim 4, wherein said using the error between the actual speed and the target speed as the input amount to the SPID controller, and outputting the current control amount specifically comprises:
using the error e(t) between the actual speed and the target speed as the input amount to the SPID controller, and outputting the current control amount u(t), wherein a value of the gain coefficient K_{S} of the squared error term is
$${K}_{S} = \frac{{K}_{S}^{′}}{r ( t )} ; {K}_{S}^{′} ∈ [ 0 , 1 ] .$$

6. The BLDC motor control method based on an improved PID controller according to claim 5, wherein said performing speed control on the BLDC motor based on the current control amount until the error meets the accuracy requirement specifically comprises:
amplifying a pulse width modulation (PWM) signal corresponding to the current control amount u(t) by a three-phase inverter and then inputting the amplified PWM signal to the BLDC motor for driving; and
collecting the actual speed of the BLDC motor through a Hall sensor, and repeating steps S2 to S5 until the error e(t) meets the accuracy requirement.
